(19) United States
(12) Patent Application Publication
(10) Pub. No.: US 2018/0281031 A1
(43) Pub. Date: Oct. 4, 2018

(54) METHOD AND CLEAN-IN-PLACE SYSTEM FOR CONVEYING TUBES

(71) Applicant: Quickdraft, Inc., Canton, OH (US)

(72) Inventors: Joseph M. Ovnic, Canton, OH (US); Kenneth J. Erskine, Chapel Hill, TN (US); Andrew P. Grow, Mogadore, OH (US); Christopher L. Tokarcik, Mogadore, OH (US); Robert Prachar, Akron, OH (US)

(21) Appl. No.: 15/908,391

(22) Filed: Feb. 28, 2018

Related U.S. Application Data
(60) Provisional application No. 62/464,685, filed on Feb. 28, 2017.
(60) Provisional application No. 62/469,116, filed on Mar. 9, 2017.

(51) Int. Cl. B08B 9/055

(52) U.S. Cl. CPC B08B 9/0557; B08B 9/0553; B08B 9/0558

(57) ABSTRACT

In a tube cleaning system and method, multiple steps can be run with a single pass by using a combination pig train. For example, an initial combination pig train may include a plurality of bristle pigs and polymer trailing pigs with a cleaning solution between each pair. One example is a first leading bristle pig and a first trailing polymer pig containing a first slug of caustic cleaning solution followed by a second bristle pig and second polymer trailing pig containing a second slug of caustic cleaning solution. Another example is a leading bristle pig, a middle bristle pig, and a trailing polymer pig with a cleaning composition disposed between the leading and middle bristle pigs and a cleaning composition disposed between the middle bristle pig and the trailing pig. Such combination pig trains are moved through the tube to be cleaned in a single pass to achieve two cleaning steps.

### CROSS REFERENCE TO RELATED APPLICATIONS

This application claims the benefit of U.S. Provisional application No. 62/464,685 filed Feb. 28, 2017 and claims the benefit of U.S. Provisional application 62/469,116 filed Mar. 9, 2017; the disclosures of both are incorporated herein by reference.

### BACKGROUND OF THE DISCLOSURE

### 1. Technical Field

The disclosure generally relates to systems and methods for cleaning the inner surfaces of conveying tubes, piping, or ducts and, more particularly, to systems and methods for cleaning tubes, piping, or ducts using a flexible pig train that engages the inner surfaces of the tubes, piping, or ducts to remove debris and clean to a microbiological level. Specifically, one configuration of the system and method uses a cleaning pig train that includes a leading plastic bristle pig to physically scrape the inner surface of the conveying structure to be cleaned.

### 2. Background Information

Conventional clean-in-place (CIP) systems and methods that are used to clean conveying tubes, pipes, or ducts to a microbiological level require copious amounts of water and chemicals which must be stored, heated to temperatures in excess of 135° F., and pumped through the tubes at a high velocity in order to create the shear forces required to scour the tube walls. The polluted waste water and chemicals then must be discharged to a waste water system for treatment. Conveying tubes used to move food products are cleaned in this manner.

Other clean-in-place systems use a pig as an instrument to flush or purge a piping system. U.S. Pat. No. 6,485,577 discloses a pig and pig launching chamber where the pig is frozen and formed from at least a component of the product stream. Another pig formed from crushed ice is disclosed in U.S. Pat. No. 6,916,383. A system using a pig train with glycol and dry ice is disclosed in U.S. Pat. No. 9,636,721.

### SUMMARY OF THE DISCLOSURE

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The system and method of the disclosure provide an alternative, effective CIP system that significantly reduces water, chemical and energy usage as well as significantly reducing the related environmental impact of the conventional CIP system requirements for water and chemical disposal. The CIP system and method described in this application can be used to clean a wide variety of piping systems. Existing piping systems can be retrofit with a pig train loader, a pig train unloader, and compressed air fittings to form this CIP system which allows the CIP method described herein to be performed.

The disclosure provides a method for cleaning a tube that includes the step of moving a pig train through the tube wherein the pig train includes a leading pig that frictionally engages the inner surface of the tube. The leading pig includes a plurality of bristles that engage the inner surface to remove debris as the pig train moves past the surface. The bristles can be disposed entirely around the circumference of the leading pig and can be disposed along the length of the leading pig. This leading pig is used with a trailing pig that is used to hold a liquid cleaning solution between. The trailing pig can be a polymer and can be a polyurethane pig.

The disclosure also provides a method for cleaning and sanitizing a tube that includes the steps of moving a bristle pig train through the tube followed by a non-bristle pig train. These steps can be repeated multiple times and the additional step of flushing with a clean water pig train can be added between the steps. A sanitizing step can be added at the end of the process.

The system and method of the disclosure are used with pipes, tubes, and ducts for conveying edible and non-edible food products including but not limited to white meats, red meats, pastes, sauces, cereals, vegetables, fruits, dairy, and also cosmetics and pharmaceuticals. Edible food conveying piping systems must be cleaned to a microbiological level. The cleaning process can be conducted once per operating day or at least once per 16 hours of operation; whichever occurs first.

One exemplary method includes the following steps: Step 1—a pig train with bristle lead pig, caustic cleaning solution and rear polyurethane pig; Step 2—repeat step one; Step 3—Poly lead pig, water slug, poly rear pig; Step 4—Poly lead pig, caustic cleaning solution, poly rear pig; Step 5—step 4 repeated multiple times to achieve desired cleaning result; Step 6—water flush lead pig, water slug, rear pig, may be repeated several times to achieve ph neutral in tubing; and Step 7—poly lead pig acid solution, poly rear pig to sanitize tubing.

In another feature of this disclosure, multiple steps can be run with a single pass by using a combination pig train. For example, an initial combination pig train may include a plurality of bristle pigs and polymer trailing pigs with a cleaning solution between each pair. One example is a first leading bristle pig and a first trailing polymer pig containing a first slug of caustic cleaning solution followed by a second bristle pig and second polymer trailing pig containing a second slug of caustic cleaning solution. Another example is a leading bristle pig, a middle bristle pig, and a trailing polymer pig with a cleaning composition disposed between the leading and middle bristle pigs and a cleaning composition disposed between the middle bristle pig and the trailing pig. Such combination pig trains are moved through the tube to be cleaned in a single pass to achieve two cleaning steps. These combination pig trains can be configured to achieve three steps in a single pass such that the time to clean the tubing system is reduced. In one example, steps 1-3 described above can be run with a first combination pig train and then steps 4-6 can be run with a second combination pig train.

The pig trains can be pushed with compressed air, pulled with a vacuum, or pushed with hydraulic force. The pig train may be driven with water, a cleaning solution or a sanitizing solution. The pig trains also can be driven mechanically such as being self-driven with powered roller or tracks, pushed with a ram, or pulled with a cable.

The disclosure provides several pig loading apparatus and a pig unloading apparatus. Two of the pig loading apparatus are configured for automated or partially-automated operation of the cleaning system.

Individual features of the disclosure may be combined to form additional combinations.

### BRIEF DESCRIPTION OF THE DRAWINGS

FIG. 1 is a view of a prior art bristle pig.

FIG. 2 is a view of a prior art SUD pig.

FIG. 3 is a perspective view of an exemplary piping system that can be cleaned with the pigs and method of this disclosure.

FIG. 4 is a top plan view of the system of FIG. 3.

FIG. 5 is a front elevation view of the system of FIG. 3.

FIG. 6 is a right side elevation view of the system of FIG. 3.

FIG. 7 is a side view of an end cap that is used to close the piping system behind a pig in one exemplary configuration.

FIG. 8 is a side view of a lead pig, cleaning solution, and trailing pig used to clean the interior surface of the piping system.

FIG. 9 is a side view of a combination pig train.

FIG. 10 is a sectional end view of a first configuration for a pig train loader with the loader closed.

FIG. 11 is a sectional end view of the first configuration for a pig train loader with the loader open.

FIG. 12 is an elevation view of FIG. 10.

FIG. 13 is a schematic end view of a second configuration for a pig train loader that is adapted to be used in an automated system.

FIG. 14 is a schematic side view of FIG. 13.

FIG. 15 is a schematic view of a third configuration for a pig train loader that is adapted to be used in an automated system.

FIG. 16 is a section view of a pig unloader.

FIG. 17 is a schematic view of a fourth configuration for a pig train loader that is adapted to be used in an automated system.

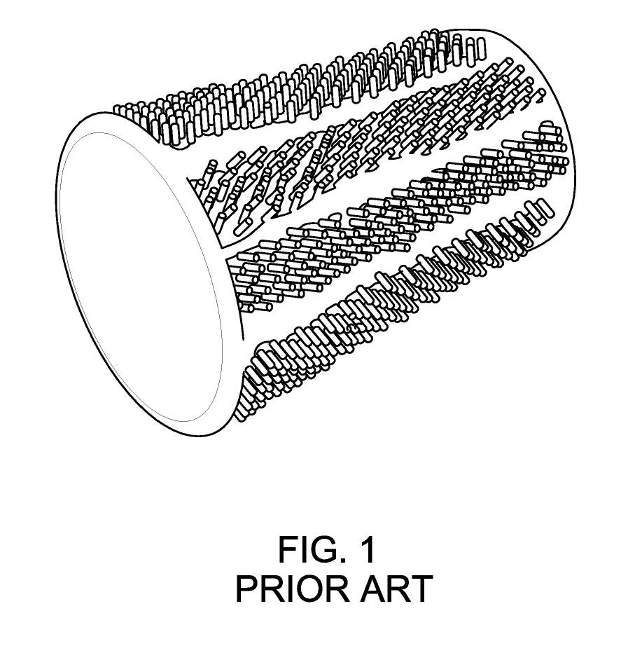

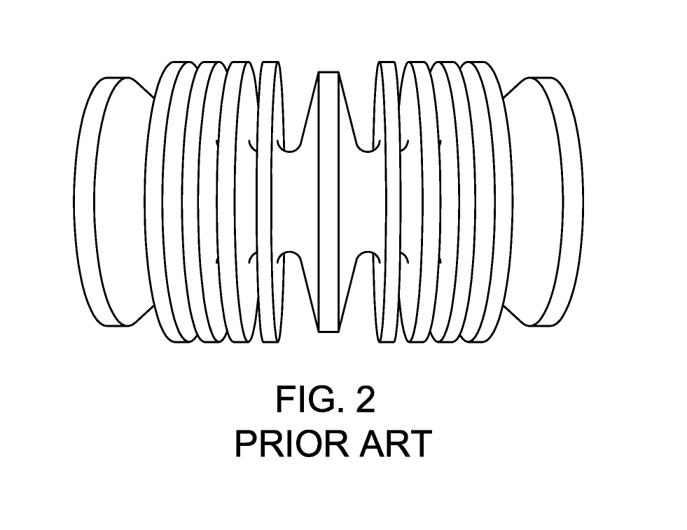

Similar numbers refer to similar parts throughout the specification.

### DETAILED DESCRIPTION OF THE DISCLOSURE

The disclosure provides different embodiments of a conveying piping system having clean-in-place components and a clean-in-place method used to clean the interior of a conveying piping system. The elements or portions of the piping system are referred to as tubes, tube sections, or ducts in this description. The interior surface is referred to as a tube wall. The system and method described herein is particularly useful for cleaning conveying piping systems used for a wide variety of materials including food and non-food-related products such as edible and non-edible food products including but not limited to white meats, red meats, pastes, sauces, cereals, vegetables, fruits, dairy, and also cosmetics and pharmaceuticals. These conveying piping systems often must be cleaned to a microbiological level.

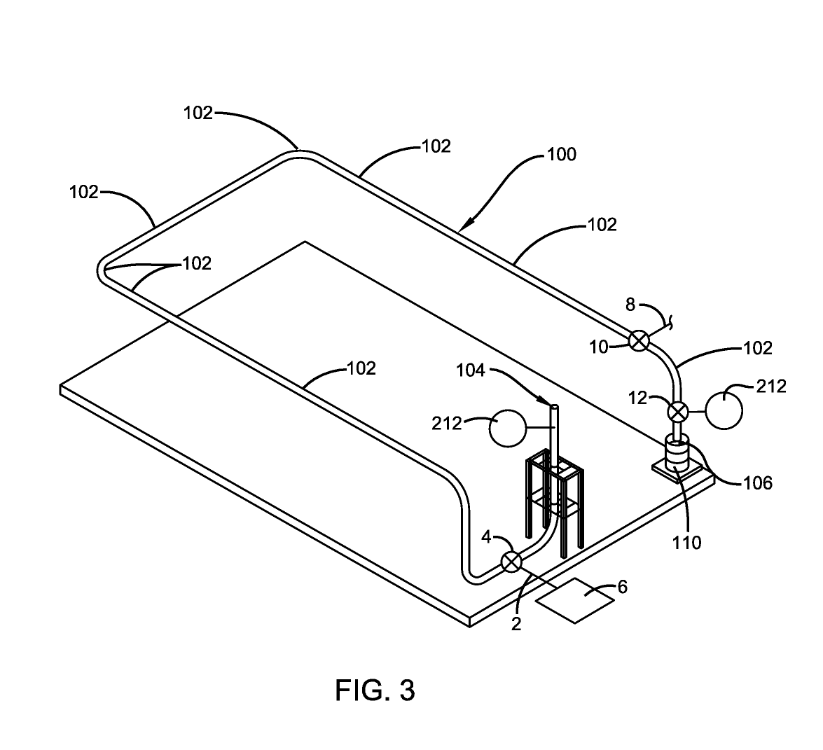

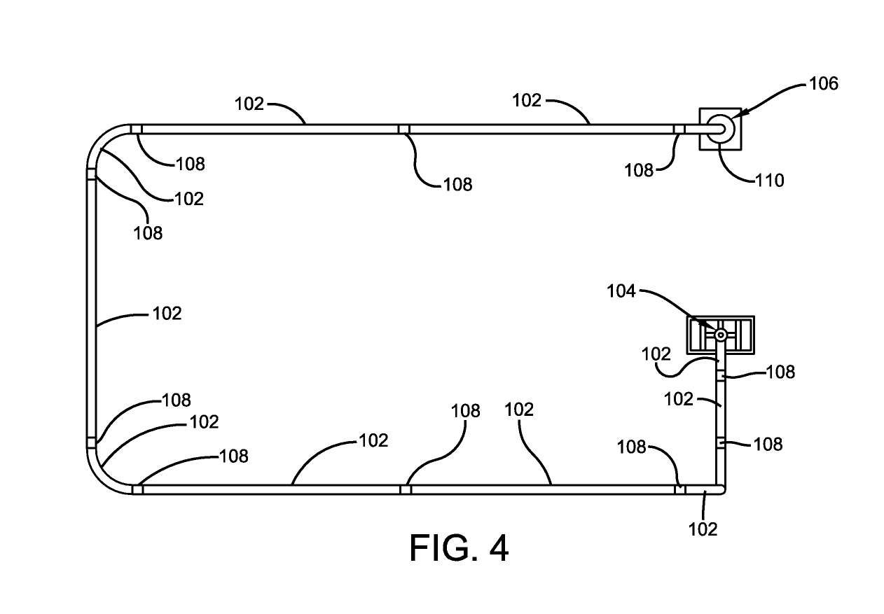

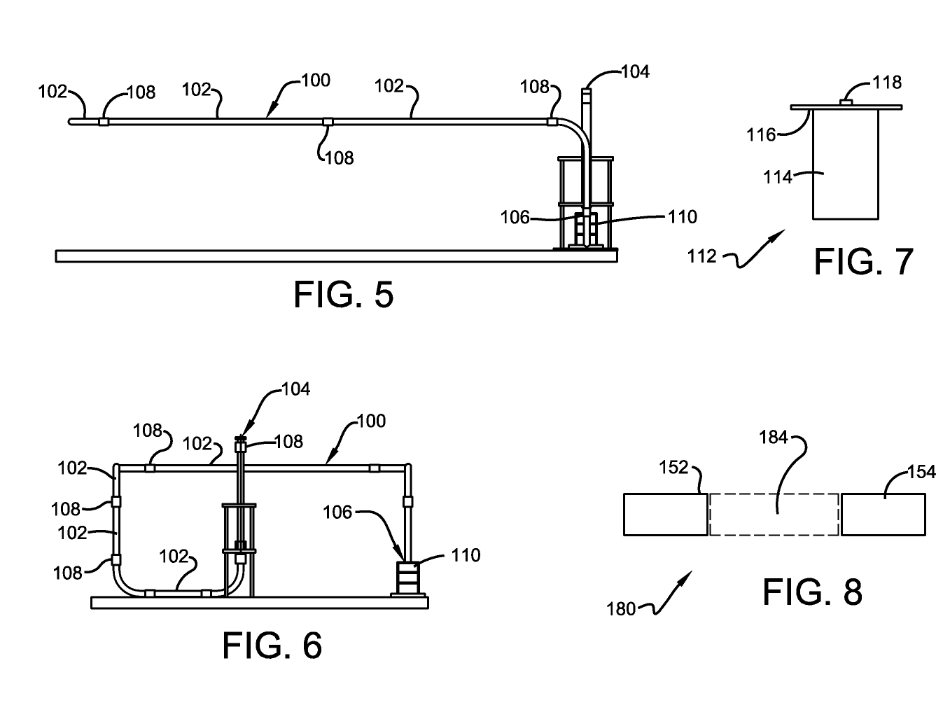

An exemplary piping system with the clean-in-place functionality described herein is indicated generally by the numeral 100 in the accompanying drawings. Piping system 100 can be part of a food or beverage processing facility, a pharmaceutical plant, or a chemical plant. Piping system 100 is typically used within these facilities to convey product from one location to another. Piping system 100 includes a plurality of individual tube sections 102 connected together to form a continuous conduit having at least one pig train inlet 104 and at least one pig train outlet 106. Pig train inlet 104 is the location where the pig trains described below are introduced into system 100. These locations can vary and be at a vertical tube section or a horizontal or angled tube section. Pig train outlet 106 is the location where the pig trains described below are removed from system 100. External compression clamps, compression couplings, sanitary flanges, or welded joints 108 are used to join tube sections 102 in the example of system 100 but other methods of joining the tubes sections 102 may be used. The arrangement of tube sections 102 in FIGS. 3-6 is exemplary and not limiting. The system and method of this disclosure may be used with a wide variety of system configurations including those that only include straight tube sections as well as those that include rises, falls, and turns. The system and method may be used with different tube diameters than described herein, different turn radii, different numbers and different configurations of corners, different tubing materials, and different tube lengths. The example depicts tube sections 102 having a six inch inner diameter disposed in a horizontal U with two legs about forty-six feet long and a base leg about twenty-six feet long (not counting the pig train loading and unloading areas).

These piping systems 100 are used to convey materials or product such as the exemplary materials described above. In order to introduce the materials into system 100, at least a single product inlet 2 (shown schematically in FIG. 3) is provided and, in other configurations, a plurality of inlets are provided. The inlet for the conveyed material can be the same as pig train inlet 104 but often are different from the pig train inlet 104. A valve 4 can be used to isolate the pig train inlet from product inlet 2 when product is being directed into system 100 from a supply of product 6. The conveyed material inlets 2 can be upstream or downstream of pig train inlet 104. System 100 includes at least one pig train outlet 106 but also may include a plurality of pig train outlets 106 controlled with a valve or valves that directs the flow in system 100 from one pig train outlet 106 to another pig train outlet 106 as desired by the operator. As with the inlets 2, pig train outlet 106 can be different from the outlet 8 of the system used to discharge the conveyed material or product. In some cases, the outlets 8 are the same. A valve 10 is used to isolate pig train outlet 106 when system 100 is in use and product is being discharged through outlet 8.

Pig train outlet 106 includes a pig catcher which functions to slow or stop the movement of the pig train. In one configuration, the pig catcher allows the pig train to be discharged from the tube into a discharge collection container 110. The operator can then remove the leading and trailing pig members from container 110 so they can be cleaned and used again. The other material caught in container 110 is disposed of according to environmental regulations. In another embodiment, the pig catcher is an area of enlarged tubing disposed at or near outlet 106. The enlarged tubing allows the compressed air or other driving substance to move around the pig train when the pig train is disposed in the enlarged tubing so that the pig train stops moving.

In some embodiments, pig train outlet 106 can be sealed with a cap or valve 12 so that compressed air may be introduced into the piping system from the outlet end. This allows a pig train to be stopped or moved back toward the inlet when such movement is desired. The introduction of compressed air from the outlet side also allows the pig train to be compressed with compressed air from both ends of the pig train while the pig train is disposed within the tubing. This squeezes the material between the leading and trailing pigs and forces it against the tube wall where the pig train is located.

In one configuration, when one of the pigs described below is placed into system 100, an end cap 112 (FIG. 7) is connected to the tube that defines inlet 104 and secured in place. End cap 112 includes a body 114 and a flange 116. A coupler 118 such as a threaded coupler or a biased snap connector extends through flange 116 to allow compressed air or liquid to be delivered into system 100 through flange 116. The pig may be moved with pressurized air that is delivered to system 100 through coupler 118. The pig also may be moved hydraulically, in which case a pressurized liquid would be tapped into coupler 118. Body 114 is disposed along the interior surface of the end of the tube section 102 that defines inlet 104 and may frictionally engage the inner surface such that body 114 slides into place with essentially no gaps between the outer surface of body 114 and the inner surface of the tube section 102 that defines inlet 104. This configuration allows body 114 to be secured in place with a clamp 108 disposed on the exterior of the tube 102 that compresses the tube against body 114.

In the exemplary configuration, body 114 has a length that is longer than the tube diameter but less than twice the length of the tube diameter. In the exemplary configuration, body 114 is ten inches long. Body 114 may be solid or hollow as long as it defines a channel to deliver compressed air or a liquid to system 100 through coupler 118. Flange 116 has a diameter larger than the inner diameter of the tube 102 that defines inlet 104 and may have a dimension that is larger than the exterior diameter of the tube 102 that defines inlet 104.

An exemplary pig train 180 is depicted in FIG. 8. Moving pig train 180 through system 100 provides an alternative to the method of flushing system 100 with high velocity water and chemicals until the interior walls are cleaned. In this configuration, pig train 180 includes leading 152 and trailing 154 pig members that define a gap between the rear of leading member 152 and the front of trailing member 154. Pig members 152 and 154 are fabricated from food grade polymer such as a food grade polyurethane. Leading pig train member 152 can be configured as a bristle pig which includes a plurality of flexible extending thin members that engage the inner surface being cleaned to scrape debris from the tube surface. These bristle pig members are used to form bristle pig trains and can be used at the beginning of the process to physically remove debris. For other pig trains, each pig member 152 and 154 is sized to slide along the inner surface of the tube sections. Each pig member is flexible and has a diameter of about six inches to match the interior size of the tube. Each is about ten inches long. Each can frictionally engage the tube wall such the fit between the tube and the pig member is tight. Each pig member can be finned.

Pig train 180 is formed when this gap between pig members 152 and 154 is substantially filled with a cleaning composition that can be a caustic cleaning solution, water, or an acid solution. The gap may be ten to twenty times the diameter of tube 102 or as small as five times the diameter. Pig train 180 can be formed by inserting leading member 152 and moving it down into a tube section far enough to allow the cleaning composition to be added. Trailing member 154 is then inserted to trap the cleaning composition between both members 152 and 154.

The volume of the cleaning composition varies with the application. A gap length of five to fifteen feet has been found to be functional in this example. In each of the steps described herein, pig train 180 is moved through the tubing with compressed air having a pressure between 30 psi and 200 psi. This first step of the cleaning process may be repeated multiple times and running the first step two to five times provides desirable results.

Pig train 180 may be slowed or stopped at a specific area of the tubes that requires additional or extra cleaning. Stopping pig train 180 provides additional time for that area of system 100 to be in contact with pig train 180. Compressed air can be applied to both the lead 152 and trailing 154 pig members to increase the pressure on the cleaning composition disposed in the gap between the pig members 152 and 154. This forces the cleaning composition against the tube walls. In addition to simply slowing or stopping pig train 180, the pig train 180 can be moved back and forth at the area by alternating the application of the compressed air. In addition to or in lieu of compressed air the pig train may be driven with water, a cleaning solution, or a sanitizing solution that is moved with hydraulic pumps.

Typically, a bristle pig train is used as the initial step in the cleaning method or as the first few steps of the method. One exemplary method includes the following steps: Step 1—a pig train with bristle lead pig 152, caustic cleaning solution 184 and rear polyurethane pig 154; Step 2—repeat step one; Step 3—Poly lead pig 152, water slug 184, poly rear pig 154; Step 4—Poly lead pig 152, caustic cleaning solution 184, poly rear pig 154; Step 5—step 4 repeated multiple times to achieve desired cleaning result; Step 6—water flush lead pig, water slug, rear pig, may be repeated several times to achieve ph neutral in tubing; and Step 7—poly lead pig acid solution, poly rear pig to sanitize tubing.

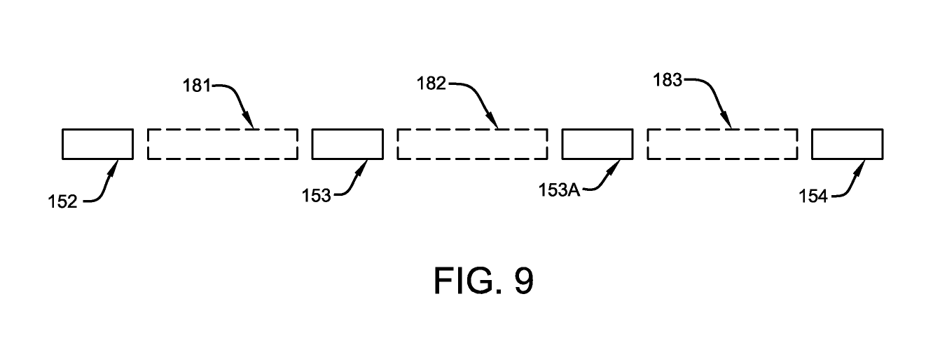

Multiple steps can be run with a single pass by using a combination pig train such as the one depicted in FIG. 9. The combination pig train configuration can be three or more pigs in a train with caustic solution/cleaning agents/water in between them. This train would then be pushed through all at once for a single pass cleaning solution.

For example, an initial combination pig train may include a plurality of bristle pigs 152 and 153 (and possibly 153A) and polymer trailing pig(s) 154 with a cleaning solution 181, 182, 183 between each pair. Another example is a first leading bristle pig and a first trailing polymer pig containing a first slug of caustic cleaning solution followed by a second bristle pig and second polymer trailing pig containing a second slug of caustic cleaning solution. Another example is a leading bristle pig, a middle bristle pig, and a trailing polymer pig with a cleaning composition disposed between the leading and middle bristle pigs and a cleaning composition disposed between the middle bristle pig and the trailing pig. Such combination pig trains are moved through the tube to be cleaned in a single pass to achieve two cleaning steps. These combination pig trains can be configured to achieve two or more cleaning steps in a single pass such that the time to clean the tubing system is reduced. In one example, steps 1-3 described above can be run with a first combination pig train and then steps 4-6 can be run with a second combination pig train.

A further example of a combination pig train is a bristle pig 152, a 10 foot long slug of caustic cleaning solution 181, another bristle pig 153, a 10 foot long slug of caustic cleaning solution 182, a SUD pig 153A, a 10 foot long slug of water flush 183, and a SUD pig 154. The SUD pig can include a plurality of sealing discs useful for moving liquid slugs. In situations where the bristle pigs leak, a SUD pig can be used behind each bristle pig to maintain the slug and push them through. The second train can include a SUD, a caustic slug, a SUD, a caustic slug, a SUD, a water flush, and a SUD.

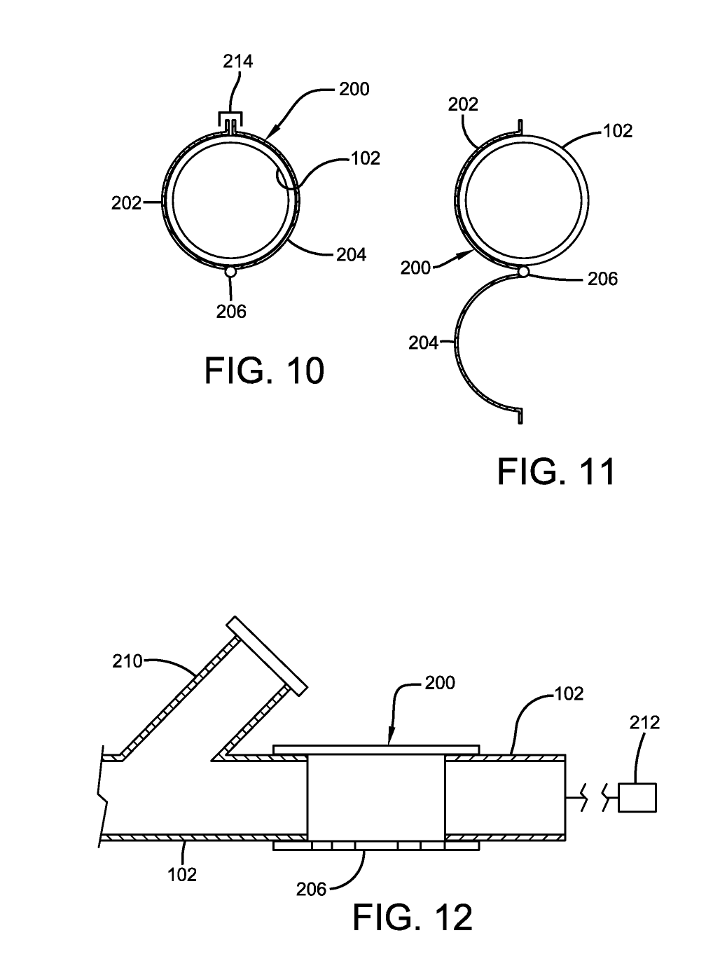

FIGS. 10-12 depict a first configuration for a manual pig loader. In this configuration, an outer sleeve 200 having at least first 202 and second 204 sections is aligned with a section of tubing 102. Sections 202 and 204 are connected with a hinge member 206 to allow at least second section 204 to be movable between closed and open configurations. In one configuration, the open condition of second section 204 allows pig members 152 and 154 and the cleaning composition to be added in alignment with tube 102. In another configuration, a loading inlet 210 is provided in a spaced location from outer sleeve 200. When loading inlet 210 is used, leading pig member 152 is inserted into tube section 102 and moved past inlet 210—which is to the left in FIG. 12. Trailing pig member 154 is added and spaced from leading pig member 152 the distance required for the desired slug of cleaning composition. Second section 204 of outer sleeve 200 is then closed and outer sleeve 200 is held closed with a clamp 214 or a plurality of clamps 214 (or locked in a sealed closed position). The cleaning composition is then added through inlet 210 to form pig train 180 and tube 102 is pressurized through a source of pressurized air 212 to move pig train 180 through piping system 100. Pig train 180 also can be moved hydraulically. In another configuration, a pair of outer sleeves 200 are provided to the left and right of inlet 210 so that both pig members 152 and 154 may be loaded at the same time. In this configuration, pig members 152 and 154 are loaded and outer sleeves 200 are closed before the cleaning composition is added to form pig train 180.

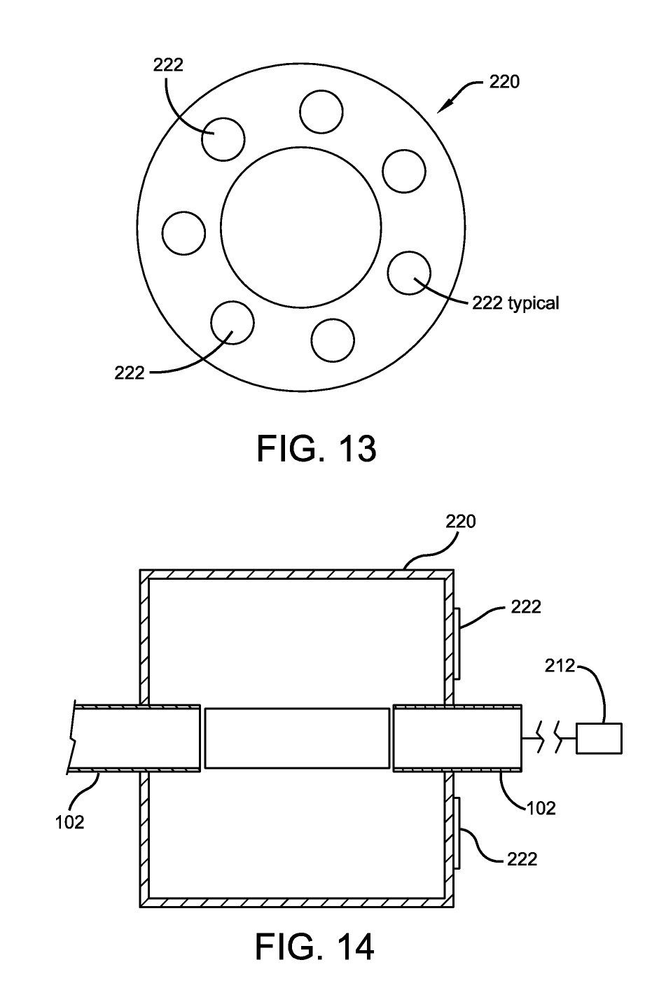

FIGS. 13-14 schematically depict a configuration for an automated pig loader wherein the plurality of pig trains required for the cleaning of system 100 may be held so that each may be automatically launched as a pig loading cylinder 220 is rotated through the steps of the method. This configuration includes a pig loading cylinder 220 having a plurality of pig loading chambers 222 that are selectively moved into alignment with a tube section 102 of piping system 100 where the pig is launched by compressed air delivered from source 212. One chamber 222 may be provided for each step of the cleaning process or one extra chamber 222 may be provided to facilitate loading. The pig trains used with the steps described above may be formed directly in loading chambers 222 or in a separate pig train forming tube that allows the pig trains to be loaded into chambers 222. Pig train 180 is the first to be launched in the above method and it is formed last. The other required pig trains are disposed sequentially about cylinder 220 such that each can be launched after the one before it has passed through piping system 100.

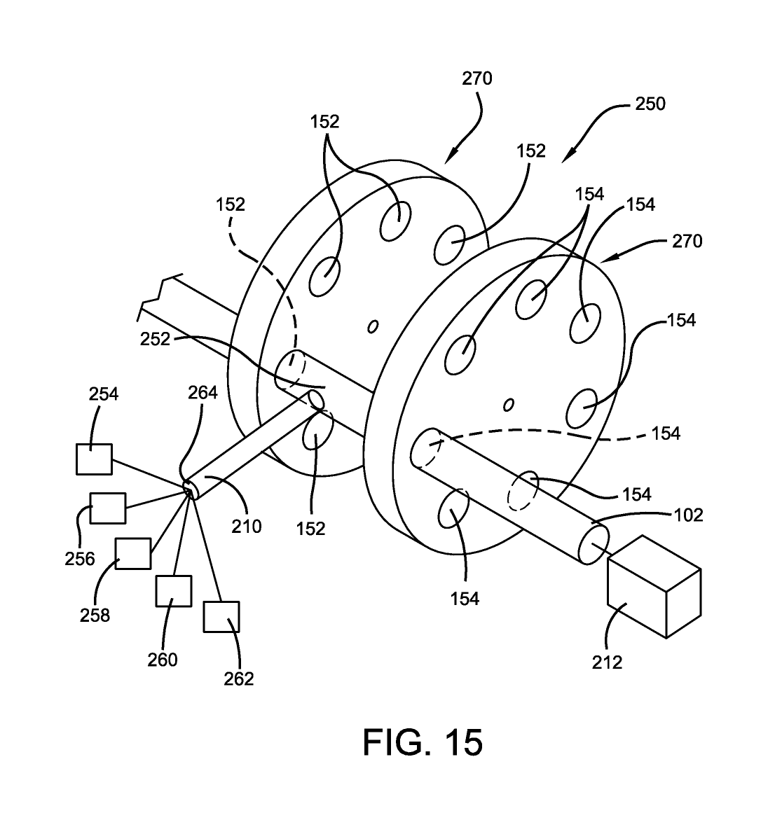

Another automated pig train loader 250 is schematically depicted in FIG. 15. This configuration of automated loader 250 separately positions leading 152 and trailing 154 pig members to positions where they are aligned with tube section 102 and a mixing chamber 252. Mixing chamber 252 receives the material that is used between pig members 152 and 154 to form the pig train. Once pig members 152 and 154 are aligned and the material is added to form the pig train, compressed air 212 is used to push the pig train through tube section 102. After that pig train is moved through tube section 102, the next pig train is created and moved.

Mixing chamber 252 is fed with an inlet 210 that is in selective communication with sources of water 254, a first cleaning composition 256, a second cleaning composition 258, chlorinated or caustic material 260, and the acid wash solution 262. A computer or digital controller 263 can be used to control the mixing of these components in mixing chamber 252 as they are needed by the method. A controllable valve 264 and appropriate pumps are used to control the addition of these materials to mixing chamber 252. In one configuration, the entire process is automated. In another configuration, one or more steps are performed manually.

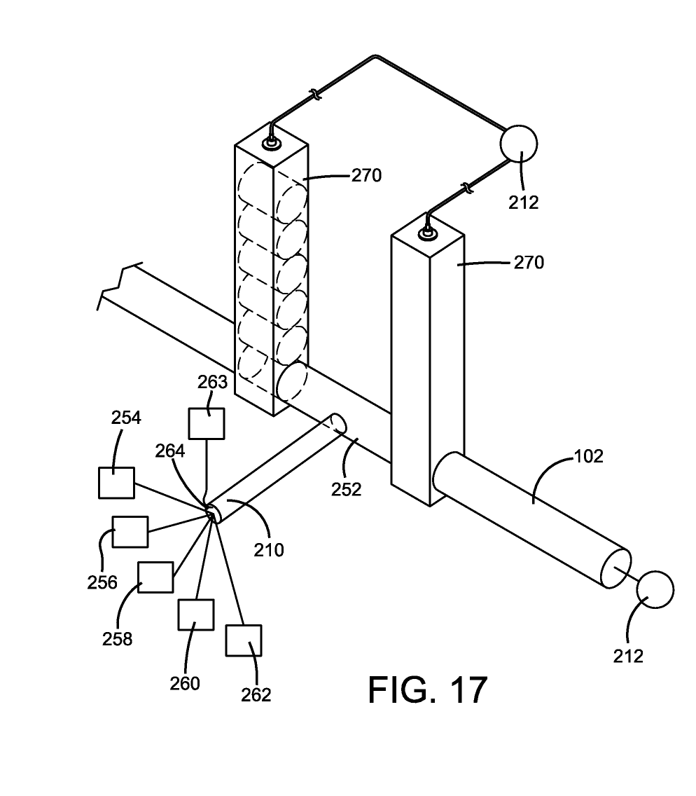

In the configuration of FIG. 15, a pair of pig carriers 270 are used to sequentially move leading 152 and trailing 154 pig members into alignment with tube section 102. Each pig carrier 270 can hold the multiple pig members that are used to form the pig trains used with the method of the disclosure. These pig carriers 270 are depicted as rotating to load the sequential pig members. Other pig carriers may slide the pig members into position. For example, FIG. 17 depicts a configuration wherein the pig members are slid linearly or rolled into position. In the FIG. 17 configuration, each pig carrier 270 holds a plurality of stacked pig members with the lowermost pig member in each carrier 270 being aligned with tube section 102. The selective application of compressed air from source 212 moves the next set of pig members into alignment when the previously-formed pig train is moved out. When pig carriers 270 are disposed above tube section 102, the pig members can be moved into position with gravity or a combination of compressed air and gravity.

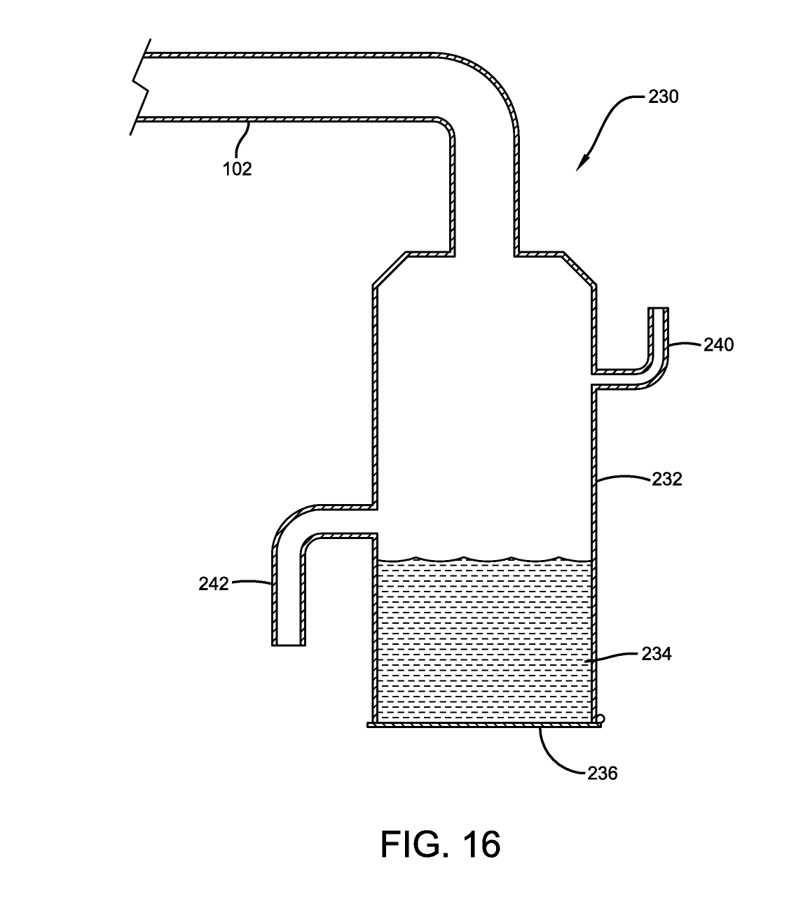

Pig trains can be removed from the piping system with an unloader 230 such as the one depicted in FIG. 16. Unloader 230 includes a container 232 having a diameter or dimension larger than the diameter of tube section 102 being cleaned so that the trailing pig member 154 will allow the compressed air behind it to expand and be vented. Water 234 may be provided at the bottom of container 232 to cushion the deceleration of pig members 152 and 154. A hinged door 236 is used to provide access to container 232 to remove pig members 152 and 154.

An upper gas venting outlet 240 is used to allow the pressurized air to escape. A liquid drain 242 is used to drain the liquid materials from the pigs. FIG. 16 is not to scale and vent 240 is disposed high enough above drain 242 so that liquid is not pushed out of vent 240. Vent 240 may be substantially smaller in diameter than tube section 102. Vent 240 may have a one inch diameter for use with a six inch tube section 102. In such a configuration, drain 242 has a four inch diameter and container 232 has an eight inch diameter. The spacing between vent 240 and drain 242 depends on the length of pig.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are an example and the invention is not limited to the exact details shown or described. For example, the configurations that are described as using compressed air to provide movement can also be used with hydraulic pumps that move water, a cleaning solution, or a sanitizing solution. Throughout the description and claims of this specification the words “comprise” and “include” as well as variations of those words, such as “comprises,” “includes,” “comprising,” and “including” are not intended to exclude additives, components, integers, or steps.

1. A combination pig train for cleaning the interior tube walls of a conveying piping system; the combination pig train comprising: at least first, second, and third pigs disposed in a portion of the conveying piping system with a liquid cleaning composition disposed between the first and second pigs and with a liquid cleaning composition disposed between the second and third pigs.

2. The combination of claim 1, wherein the first and second pigs are bristle pigs.

3. The combination of claim 2, wherein the third pig is a polymer pig.

4. The combination of claim 3, wherein the third pig is a multiple disc pig.

5. The combination of claim 3, further comprising a fourth pig in the pig train disposed between the second and third pigs; the fourth pig being a bristle pig.

6. The combination of claim 1, further comprising a fourth pig in the pig train; a slug of flush water disposed between the third pig and the fourth pig.

7. The combination of claim 6, wherein the third and fourth pigs are polymer pig.

8. The combination of claim 7, wherein the third and fourth pigs are multiple disc pigs.
